(19) United States
(12) Patent Application Publication
(10) Pub. No.: US 2006/0262110 A1
(43) Pub. Date: Nov. 23, 2006

(54) DRIVING METHOD FOR DISPLAY DEVICE

(75) Inventors: Takayuki Fukuda, Kumamoto (JP); Yukio Ijima, Kumamoto (JP); Shigeru Yachi, Tokyo (JP); Yuichi Masutani, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/419,072

(22) Filed: May 18, 2006

(30) Foreign Application Priority Data
May 20, 2005 (JP) 2005-147973

(51) Int. Cl. G09G 5/00

(52) U.S. Cl. 345/204

(57) ABSTRACT

A driving method for a display device that includes: plural read signal lines; plural selectors connected to the read signal lines; plural gate signal lines; a photo-sensor connected to one of the read signal lines based on whether the one of the gate signal lines are switched on; and a detection circuit that detects an output value of the photo-sensor and selectively establishes connections with the read signal lines based on whether the selectors are switched on, includes: switching on one of the selectors; switching on the one of the gate signal lines; and detecting the output value. A timing of switching on the one of the gate signal lines is delayed by a specific period from a timing of switching on the one of the selectors. An influence of switching noises to the detection of the output value remains during the specific period.

### BACKGROUND OF THE INVENTION

1. Field of the Invention

The present invention relates to a driving method for a display device, and is suitably applied to a liquid crystal display incorporating photo-sensors and provided with a touch panel function.

2. Description of the Related Art

In a liquid crystal device incorporating photo-sensors in related art, display unit is used as an input screen for inputting a coordinate, and a display mode and a coordinate detection mode are switched in time division by switching unit. Since the display portion and the input portion are made as one unit, a display position and an input position can be brought into coincidence with each other without performing an offset adjustment or a gain adjustment using a signal processing circuit. The display position by the display unit and the input position by the coordinate value detection unit can be therefore brought into coincidence with each other, which enables satisfactory position accuracy to be achieved (for example, JP-A-Hei. 4-222018, FIG. 1).

### SUMMARY OF THE INVENTION

However, in the liquid crystal display incorporating photo-sensors as described above, since integrators are provided respectively to plural signal lines, the number of signal lines is increased as the display screen increases in size and achieves higher definition and higher resolution. Accordingly the number of integrators is increased proportionally. This raises a problem that the cost increases as an area of the display is enlarged.

As a method for solving this problem, a method as follows has been proposed. That is, selectors, each including a thin film transistor (hereinafter, abbreviated as TFT) connected to a read signal line of a photo-sensor, are provided inside a display device. Plural read signal lines in a set are connected to each integrator via one selector, and the number of integrators is reduced by adopting the time division method. The detection circuit itself thus becomes more compact and an increase of the cost can be suppressed. When this method is adopted, however, influence of switching noises generated when the selectors are switched on and coupling noises to the read signals lines generated by a polarity inversion of a potential at the source signal lines after the gate signal lines are switched on give adverse influences to the potential at the detection timing before the integration period ends. This raises a problem that it is difficult to detect a threshold value for deciding whether the photo-sensor is on or off.

The present invention has been made in view of the above circumstances and provides a driving method for a display device. According to an aspect of the invention, the driving method for the display device may detect the threshold value for deciding whether the photo-sensor is on of off in a reliable manner by suppressing influences of various noises to which the read signal lines of the photo-sensors are subjected.

According to another aspect of the invention, there is provided the driving method for the display device incorporating photo-sensors and including a detection circuit that detects output of the photo-sensors and selectively establishes a connection with an arbitrary read signal line by plural selectors connected to plural read signal lines, characterized in that timing at which the gate signal lines are switched on is delayed by a specific period from timing at which the selectors are switched on. During the specific period, an influence of switching noises generated after the selectors is switched on.

According to another aspect of the invention, there is provided a driving method for a display device that includes: a plurality of source signal lines formed on an insulation substrate; a plurality of read signal lines formed to be parallel to the source signal lines; a plurality of selectors connected to the read signal lines; a plurality of gate signal lines being separated from the source signal lines via an insulation film and intersecting with the source signal lines in a planar view; a photo-sensor formed in the vicinity of an intersection of one of the source signal lines and one of the gate signal lines, and connected to one of the read signal lines based on whether the one of the gate signal lines are switched on; and a detection circuit that detects an output value of the photo-sensor and selectively establishes connections with the read signal lines based on whether the selectors are switched on, includes: switching on one of the selectors; switching on the one of the gate signal lines; and detecting the output value of the photo-sensor, wherein a timing at which the one of the gate signal lines is switched on is delayed by a specific period from a timing at which the one of the selectors is switched on; and an influence of switching noises generated after switching on the one of the selectors to the detection of the output value remains during the specific period.

According to another aspect of the invention, the detection accuracy may be enhanced in a liquid crystal display incorporating photo-sensors by suppressing influences of various noises to which the read signal lines of the photo-sensors are subjected, and thereby enabling a detection of the threshold value for deciding whether the photo-sensor is on or off to be performed in a reliable manner.

### BRIEF DESCRIPTION OF THE DRAWINGS

FIG. 1 is a view schematically showing a display device according to a first embodiment of the invention.

FIG. 2 is a detailed view of a portion from a photo-sensor to a detection circuit in FIG. 1.

FIG. 3 is a view used to describe a general driving method for a display device.

FIG. 4 is a view used to describe a driving method for a display device according to a first embodiment of the invention.

FIG. 5 is a view used to describe a driving method for a display device according to a second embodiment of the invention.

FIG. 6 is another view used to describe the driving method for the display device according to the second embodiment.

FIG. 7 is a view schematically showing a display device according to a third embodiment of the invention.

### DETAILED DESCRIPTION OF THE INVENTION

### First Embodiment

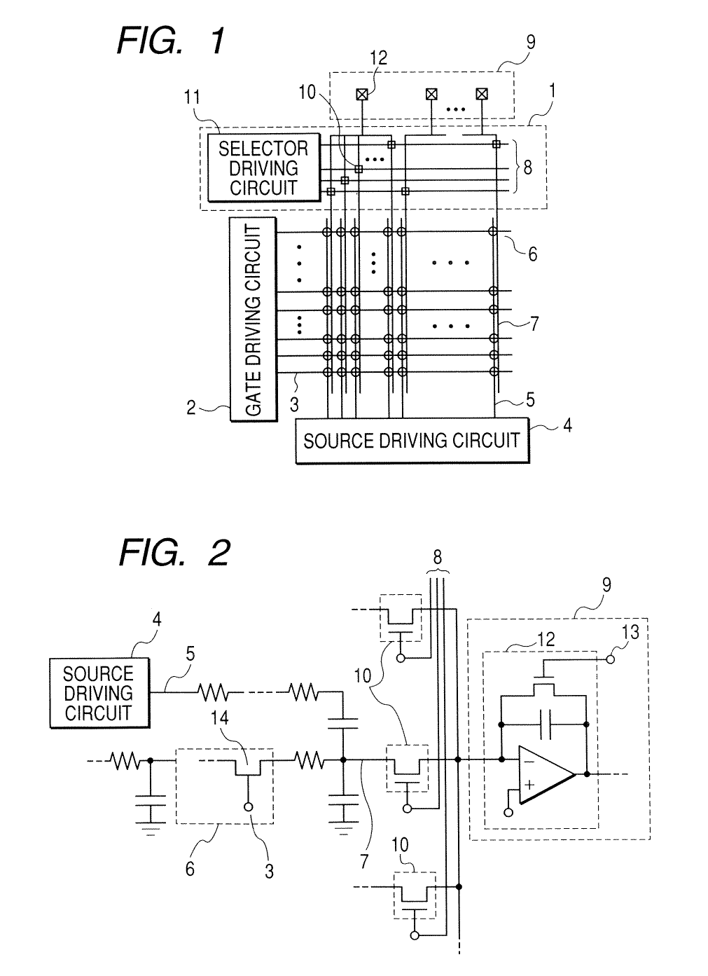

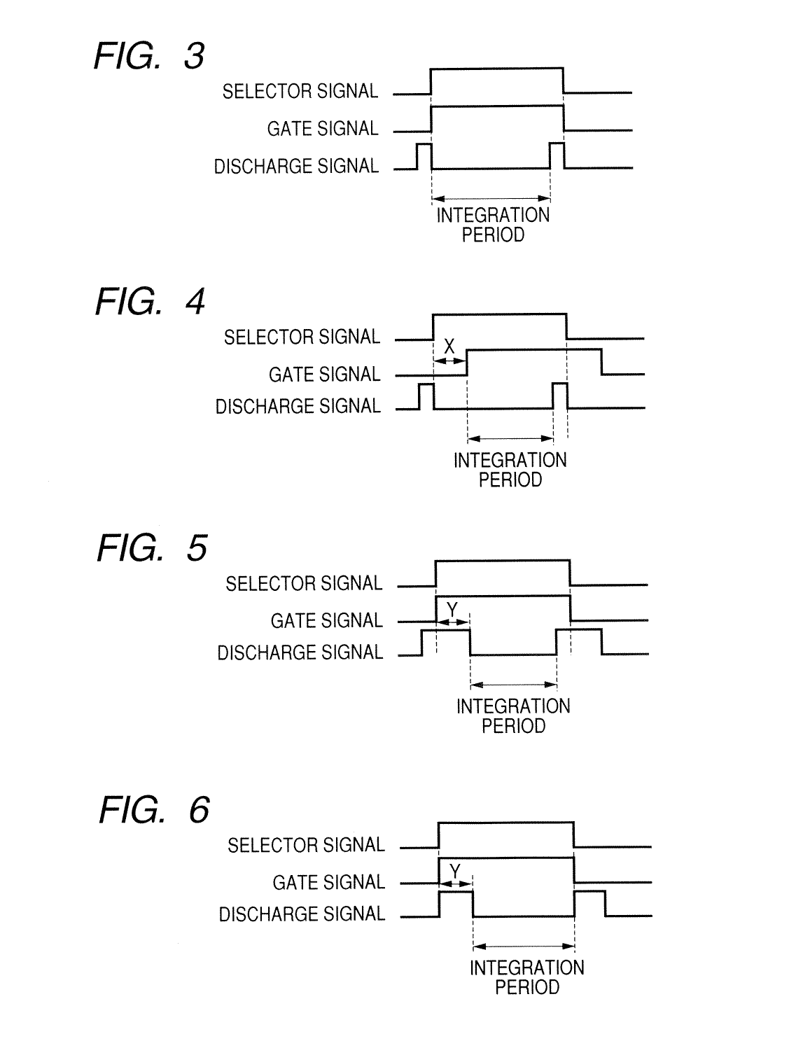

A first embodiment of the invention will be described with reference to FIG. 1 through FIG. 4. FIG. 1 is a view schematically showing a display device according to the first embodiment of the invention. FIG. 2 is a detailed view of a portion from a photo-sensor to a detection circuit in FIG. 1. FIG. 3 is a view used to describe a general driving method for the display device. FIG. 4 is a view used to describe a driving method for a display device in the first embodiment of the invention.

FIG. 1 schematically shows the configuration of a liquid crystal display incorporating photo-sensors and equipped with a selector 1. An active-matrix liquid crystal display includes an insulation substrate on which are formed gate signal lines 3 outputted from a gate driving circuit 2 and source signal lines 5 outputted from a source driving circuit 4. The active-matrix liquid crystal display also includes read signal lines 7 connected to photo-sensors 6, selector lines 8 disposed to be separated from the read signal lines 7 via an insulation film and intersects with the read signal lines 7 in a planar view in a region outside the display region, and TFTs 10 for selectors disposed at the respective intersections for selecting an arbitrary read signal line and connected to a detection circuit 9. The selector 1 includes a selector driving circuit 11 that drives the selector lines 8, and includes the TFTs 10 for selectors used to reduce the number of integrators 12 in relation to the number of the read signal lines 7 by means of time division in a space between the read signal lines 7 and the detection circuit 9 including the integrators 12. When configured in this manner, the number of circuits in integrators (detection circuit) can be reduced. FIG. 2 is a detailed view of a portion from the photo-sensor 6 to the detection circuit 9. The integrator 12 forming the detection circuit 9 receives an input of a discharge signal 13 to reset the integrator. Reference numeral 14 denotes a TFT in the output stage forming the photo-sensor. Position information is acquired as a value of the photo-sensor 6 by detecting the presence or absence of irradiation of light onto the photo-sensor 6 by the detection circuit 9 via the read signal line 7.

A general driving method in the related art for the liquid crystal display incorporating photo-sensors configured as described above will now be described with reference to FIG. 3. For the read signal line 7 connected to the photo-sensor 6 within the display area to control the TFT 14, it is general to also use a gate signal of the TFT that drives a pixel (TFT 14 shown in FIG. 2 is not the TFT connected to the pixel, and it is the TFT connected to the photo-sensor; however, because the same potential as that of the gate signal line 3 is supplied to the gate of the TFT 14, reference numeral 3 is labeled to the gate of the TFT 14). Integration is started in such a manner that charges in the internal capacitor of the integrator 12 are cleared by switching on (High) a discharge signal to reset the detection circuit 9 (integrator 12), after which the reset is cancelled (the discharge signal is switched OFF (Low)) substantially at the same time at which the selector (selector signal) and the gate signal line are switched on (High). The term, “substantially at the same time” referred to herein does not necessarily means exactly the same instant, and it includes a range within which the effect of the invention can be achieved.

With the driving method described above, however, switching noises generated after the selector is switched on give adverse influences to the read signal line, which affects the detection accuracy. By taking this into account, as is shown in FIG. 4, the timing at which the gate signal line is switched on is set to be delayed from the timing at which the selector is switched on by a first specific period X during which the read signal line remains unsusceptible to the switching noises generated after the selector is switched on. It is preferable that the first specific period X be substantially equal to a time constant of the read signal line. To be more concrete, when 3 to 25 μs is given, it is possible to avoid the influences of the switching noises generated after the selector is switched on almost completely. It is, however, more preferable that 3 to 15 μs is given in order to avoid the influences in a more reliable manner for the detection to be performed during the following integration period. Since a following read signal line is read in each even period, the period during which the selector signal remains High for one even cycle, and the actual integration period in the integration period in the drawing is a period during which both the gate signal and the selector signal are High while the discharge signal of the integrator is Low.

In a case where the on/off of the photo-sensor is discerned using output potential of the integrator when light is irradiated to the photo-sensor and when light is shielded on the basis of a given threshold value by providing a comparator or the like at the latter stage of the integrator 12 in the detection circuit 9 of FIG. 2, a normal detection is difficult for some display patterns due to a variation of the threshold value. In such a case, the detection accuracy can be enhanced further by adding a function of identifying the display pattern to the timing controller for the display device to enable automatic control of the threshold value frame by frame or for every even period.

### Second Embodiment

A second embodiment of the invention will now be described with reference to FIG. 5 and FIG. 6. FIG. 5 is a view used to describe a driving method for a display device according to the second embodiment of the invention. FIG. 6 is another view used to describe the driving method for the display device according to the second embodiment of the invention.

FIG. 5 and FIG. 6 are views used to describe the driving method for the display device according to the second embodiment, and a difference from the first embodiment above will be described. Referring to FIG. 5, after the integrator is reset (the discharge signal is set to High) and subsequently the selector and the gate signal line are switched on substantially at the same time, the timing at which the reset of the integrator is cancelled (the discharge signal is set to Low) is set to be delayed from the timing at which the selector and the gate signal line are switched on by a second specific period Y during which the read signal line remains unsusceptible to the coupling noises between the source signal line and the read signal line generated after a polarity inversion of the source signal line. Generally, the polarity inversion of the source signal line occurs when the gate signal line is switched on. It is therefore possible to avoid the influences of the coupling noises between the source signal line and the read signal line to the read signal line by the driving method described above. When approximately 3 to 20 μs is given as the second specific period Y, it is possible to avoid the influences of the coupling noises between the source signal line and the read signal line to the read signal line. It is, however, more preferable that 3 to 10 μS be given in order to avoid the influences in a more reliable manner for the detection to be performed during the following integration period.

Referring to FIG. 6, the timing at which the integrator is reset (the discharge signal is set to High) by the driving method as shown in FIG. 5 is set substantially at the same time as the timing at which the selector signal and the gate signal are switched on. By fabricating the driving method for setting the discharge signal to High substantially at the same time when the selector is switched on in this manner, in addition to the effect of the driving method as shown in FIG. 5, not only is it possible to set the integration period sufficiently long, but it is also possible to enhance the detection accuracy further by avoiding adverse influences. For example, the offset (initial value) is applied to the inside of the integrator due to the noises generated after the selector is switched on.

### Third Embodiment

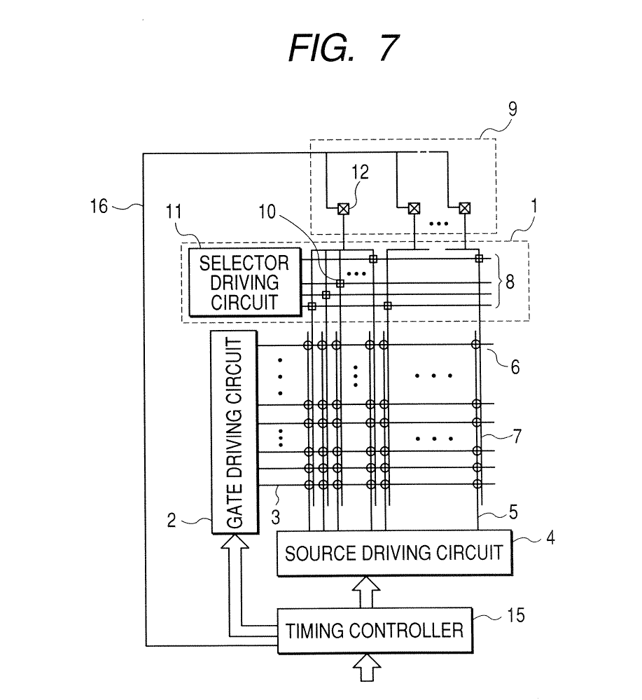

A third embodiment of the invention will now be described with reference to FIG. 7. FIG. 7 is a view schematically showing a display device according to the third embodiment. In FIG. 7, like components are labeled with like reference numerals with respect to FIG. 1 through FIG. 6, and the difference will be described.

According to the third embodiment, in addition to the configuration shown in FIG. 1, a timing controller 15 for a display device and a control signal line 16 inputted into the detection circuit 9 from the timing controller 15 are provided. In a case where the function of identifying the display pattern is additionally provided, for a display pattern for which the coupling noises given from the source signal line 5 to the read signal line 7 are expected or judged to be large, the noise-induced influences can be avoided by further extending the discharge period (second specific period Y) in the second embodiment. For a display pattern for which the noises are expected or judged to be minor, the detection accuracy can be enhanced further by setting the integration period longer by shortening the discharge time. By automatically controlling the discharge period frame by frame or for each even period by means of the timing controller in this manner, it is possible to enhance the detection accuracy.

It goes without saying that the same effect can be achieved by adopting the driving methods of the first through third embodiments either solely or in appropriate combination.

In addition, by putting a detection circuit adopting the driving method of any of the first through third embodiments, a selector driving circuit, and a gate driving circuit together on an existing circuit board for a display device, the circuit size can be reduced; moreover, it is possible to automatically control the threshold value or the discharge period by identifying the display pattern in a simpler manner in order to discern the on/off of the photo-sensor.

The entire disclosure of Japanese Patent Application No. 2005-147973 filed on May 20, 2005 including specification, claims, drawings and abstract is incorporated herein be reference in its entirety.

What is claimed is:

1. A driving method for a display device, the display device including:
a plurality of source signal lines formed on an insulation substrate;
a plurality of read signal lines formed to be parallel to the source signal lines;
a plurality of selectors connected to the read signal lines;
a plurality of gate signal lines being separated from the source signal lines via an insulation film and intersecting with the source signal lines in a planar view;
a photo-sensor formed in the vicinity of an intersection of one of the source signal lines and one of the gate signal lines, and connected to one of the read signal lines based on whether the one of the gate signal lines are switched on; and
a detection circuit that detects an output value of the photo-sensor and selectively establishes connections with the read signal lines based on whether the selectors are switched on, the driving method comprising:
switching on one of the selectors;
switching on the one of the gate signal lines; and
detecting the output value of the photo-sensor,
wherein a timing at which the one of the gate signal lines is switched on is delayed by a specific period from a timing at which the one of the selectors is switched on; and
an influence of switching noises generated after switching on the one of the selectors to the detection of the output value remains during the specific period.

2. The driving method for the display device according to claim 1, wherein:
the specific period is substantially equal to a time constant of the read signal lines.

3. The driving method for the display device according to claim 1, wherein:
the specific period is 3 to 15 μs.

4. A driving method for the display device including:
a plurality of source signal lines formed on an insulation substrate;
a plurality of read signal lines formed to be parallel to the source signal lines;
a plurality of selectors connected to the read signal lines;
a plurality of gate signal lines being separated from the source signal lines via an insulation film and intersecting with the source signal lines in a planar view;
a photo-sensor formed in the vicinity of an intersection of one of the source signal lines and one of the gate signal lines, and connected to one of the read signal lines based on whether the one of the gate signal lines are switched on; and
a detection circuit including an integrator, the integrator detecting an output value of the photo-sensor and selectively establishes connections with the read signal lines based on whether the selectors are switched on, the driving method comprising:
resetting the integrator;
switching on one of the selectors;
switching on the one of the gate signal lines substantially at the same time of switching on the one of the selectors;
canceling reset of the integrator; and
detecting the output value of the photo-sensor;
wherein a timing of canceling the reset is delayed by a specific period from a timing at which the one of the selectors and the one of the gate signal lines are switched on;
an influence of coupling noises between the source signal lines and the read signal lines generated after a polarity inversion of the source signal lines to the detection of the output value remains during the specific period.

5. The driving method of a display device according to claim 4, wherein:
the specific period is 3 to 10 μs.

6. The driving method for the display device according to claim 4, wherein:
the timing of canceling the reset is substantially at the same time of switching on the one of the selectors and the one of the gate signal lines.

7. A driving method for the display device including:
a plurality of source signal lines formed on an insulation substrate;
a plurality of read signal lines formed to be parallel to the source signal lines;
a plurality of selectors connected to the read signal lines;
a plurality of gate signal lines being separated from the source signal lines via an insulation film and intersecting with the source signal lines in a planar view;
a photo-sensor formed in the vicinity of an intersection of one of the source signal lines and one of the gate signal lines, and connected to one of the read signal lines based on whether the one of the gate signal lines are switched on; and
a detection circuit including an integrator, the integrator detecting an output value of the photo-sensor and selectively establishes connections with the read signal lines based on whether the selectors are switched on, the driving method comprising:
resetting the integrator;
switching on one of the selectors;
switching on the one of the gate signal lines;
canceling reset of the integrator; and
detecting the output value of the photo-sensor, wherein a timing at which the one of the gate signal lines is switched on is delayed by a first specific period from a timing at which the one of the selectors is switched on;
an influence of switching noises generated after switching on the one of the selectors to the detection of the output value remains during the first specific period;
a timing of canceling of the reset is delayed by a second specific period from a timing at which the one of the gate signal lines is switched on; and
an influence of coupling noises between the source signal lines and the read signal lines generated after a polarity inversion of the source signal lines to the detection of the output value remains during the second specific period.

8. The driving method of a display device according to claim 7, wherein:
the first specific period is 3 to 15 μs.

9. The driving method of a display device according to claim 7, wherein:
the second specific period is 3 to 10 μs.
